(19) United States
(12) Patent Application Publication
(10) Pub. No.: US 2003/0095246 A1
(43) Pub. Date: May 22, 2003

(54) Anticounterfeit feature authentication pen

(76) Inventor: Liao Hsia Jung, Taipei City (TW)

Correspondence Address: Liao Hsia Jung, PO Box 82-144, Taipei, TW

(21) Appl. No.: 09/987,782

(22) Filed: Nov. 16, 2001

(51) Int. Cl. G06K 9/74

(52) U.S. Cl. 356/71

(57) ABSTRACT

An anticounterfeit feature authentication pen includes a pen barrel with detachably connected front and rear portions. The pen barrel front portion has a refill disposed therein for writing purposes. The pen barrel rear portion has a lighting device disposed therein for authenticating anticounterfeit features. The pen barrel rear portion has a tubular wall formed with an elongate hole that is sealed by a light permeable plate. The lighting device includes an activator circuit board disposed in the pen barrel rear portion, a light reflective hood disposed at an inner face end of the light permeable plate, a black cold cathode tube disposed between the light reflective hood and the light permeable plate, a button type battery seat insertable and removable via a connecting end of the pen barrel rear portion, and a power switch disposed at the pen barrel rear portion at a suitable position.

### BACKGROUND OF THE INVENTION

(a) Field of the Invention:

Counterfeiting of valuable documents, such as bank notes, credit cards, bonds, etc., has adverse effects on a country's economy and financial order. As the technique of counterfeiting has improved to an extent that the forged documents cannot be easily identified with the naked eyes, bank notes, credit cards, and other valuable documents are generally provided with security means to prevent counterfeiting. Fluorescent fibers embedded in paper (card) to serve an anticounterfeit feature are very effective in preventing counterfeiting and is widely adopted by many countries. Since the fluorescent anticounterfeit feature is visible only under ultraviolet light, there have been developed various types of currency authentication devices that provides a verification light source by employing a fluorescent lamp, and that currently fall into two main types, i.e., desk-top and portable. The desk-top type is relatively large in size and has more functions (generally known as currency authentication machines), and is especially designed for cashiers in shops and stores. The portable type is relatively small (generally known as currency authentication pen), which mainly verifies the fluorescent anticounterfeit feature and which can be carried conveniently to provide mobility. The invention is directed to improving conventional currency authentication pens.

(b) Description of the Prior Art:

In its earlier stage of development, the so-called currency authentication pens utilized a florescent lamp as a light source, and hence their size could not be easily reduced. Therefore, although they are referred to as “pens”, they merely provided a single authentication function. As such, users did not find them useful and would forget to bring them along or find them inconvenient to carry. Therefore, an LED ultraviolet currency authentication pen (see FIG. 1) has been developed, which utilizes the compactness of LED 2. A pen barrel rear portion 1 is formed into a flashlight structure to facilitate carrying and writing. However, there are various disadvantages in terms of practicality. First, the lighting efficiency of conventional LEDs is not ideal when used for lighting purposes, resulting in poor recognition effect under normal light. Second, as wavelengths of LEDs are relatively stable, and as the visible wavelengths of fluorescence in bank notes vary from country to country, limitations exist with respect to the range of adaptability. Therefore, it is desirable to have a currency authentication pen that is convenient to carry and use, that can be used to authenticate bank notes of different countries, and that provides good lighting efficiency.

### SUMMARY OF THE INVENTION

The primary object of the invention is to provide an anticounterfeit feature authentication pen which overcomes the problems associated with the prior art. the anticounterfeit feature authentication pen includes a pen barrel with detachably connected front and rear portions. The pen barrel front portion has a refill disposed therein for writing purposes. The pen barrel rear portion has a lighting device disposed therein for authenticating anticounterfeit features. The invention is characterized in that the pen barrel rear portion has a tubular wall formed with an elongate hole that is sealed by a light permeable plate. The lighting device includes an activator circuit board disposed in the pen barrel rear portion, a light reflective hood disposed at an inner face end of the light permeable plate, a black cold cathode tube disposed between the light reflective hood and the light permeable plate, a button type battery seat insertable and removable via a connecting end of the pen barrel rear portion, and a power switch disposed at the pen barrel rear portion at a suitable position, thereby achieving a high-efficiency ultraviolet anticounterfeit feature authentication effect and a writing function.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view of a conventional ultraviolet anticounterfeit feature authentication pen;

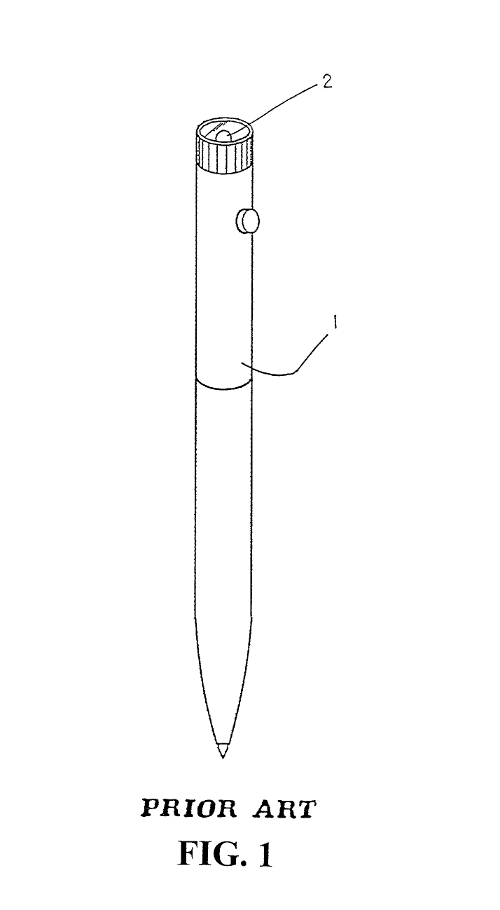

FIG. 2 is a schematic view of an embodiment of the present invention;

FIG. 3 is a schematic view illustrating structural relationship of the embodiment of the present invention; and

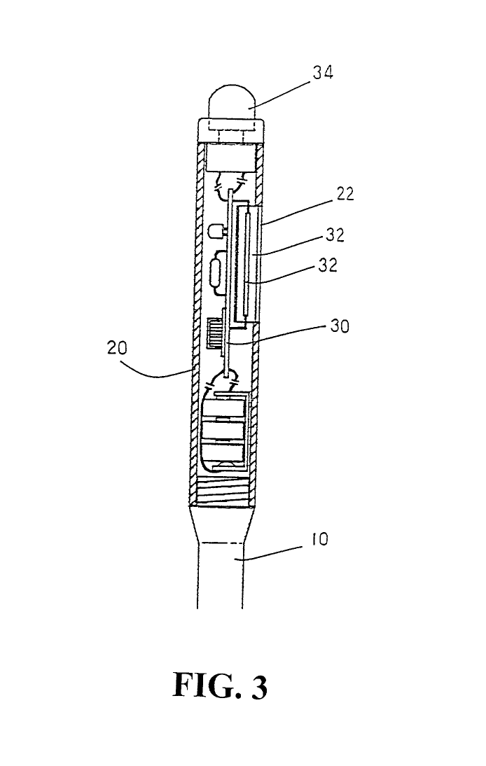

FIG. 4 is a schematic view of the embodiment of the present invention in a state of use.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

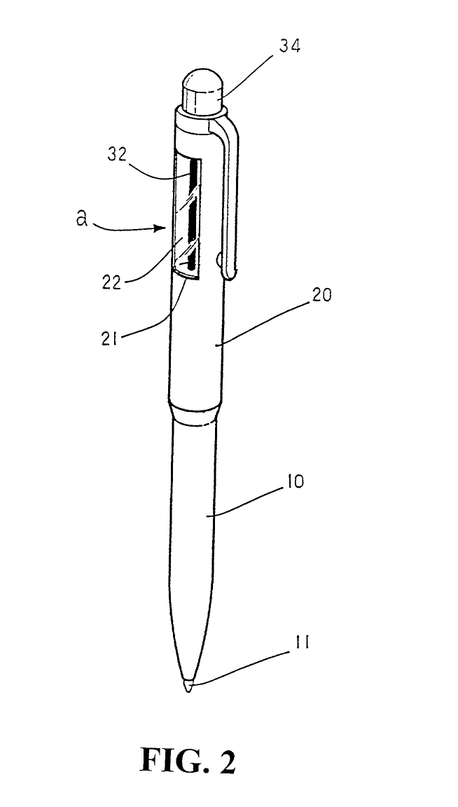

Referring to FIG. 2, an anticounterfeit feature authentication pen according to the invention includes pen barrel front portion 10 and pen barrel rear portion 20, refill 11, and lighting device (a), which are detachably assembled as a whole. The pen barrel front portion 10 is disposed to receive refill 11 of a corresponding length. The pen barrel rear portion 20 is hollow and tubular, and has a bottom end that can threadedly engage or connect with a rear end of pen barrel front portion 10. One side of the tubular wall if formed with a suitably long elongate hole 21, which is covered by a light permeable plate 22. The lighting device (a) includes an activator circuit board 30 disposed in pen barrel rear portion opposite to light permeable plate 22. A light reflective hood 31 provided at an inner face end of light permeable plate 22. A black cold cathode tube 32 is interposed between light reflective hood 31 and light permeable plate 22 with conductive legs connected to activation circuit board 30. A button type battery seat 33 is connected to circuits of activation circuit board 30 to be insertable and removable via a bottom end of pen barrel rear portion 20. A power switch 34, which may be a conventional press switch, is provided at a distal end of pen barrel rear portion 20 and connected to the circuits of activator circuit board 30.

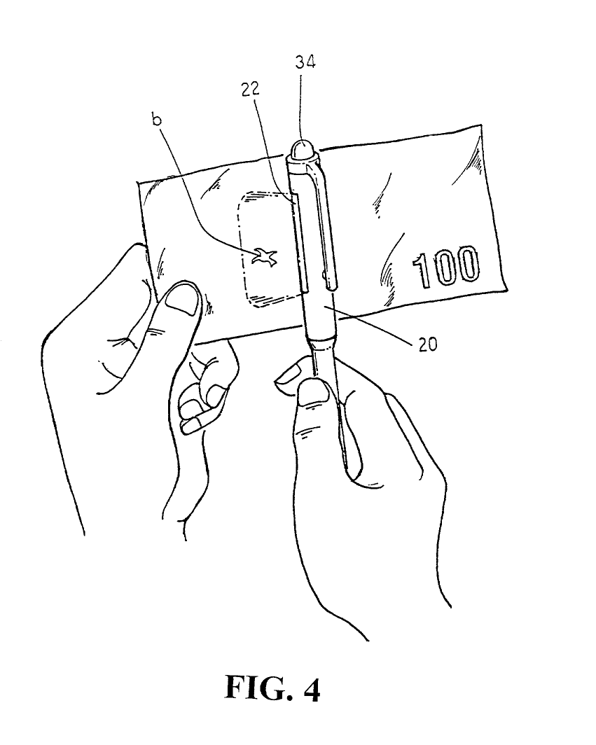

In the anticounterfeit feature authentication pen as described above, since the cathode tube 32 is small in size and has high power characteristic, it can be hidden in the pen barrel. Besides, since its wavelength is in the range of 300 nm˜400 nm, it can have excellent light effect under normal light, and can adapt to different fluorescent wavelengths in the authentication of bank notes of different countries, thereby enabling the user to carry the pen around conveniently with no territorial limitations. When the pen is used to authenticate bank notes (see FIG. 4), the light permeable plate 22 is oriented toward the surface of the object (such as bank notes, credit notes, identity documents, valuable documents) to be authenticated, the power switch 34 is turned on to activate the cathode tube 32 so that ultraviolet light passes through light permeable plate 22 to form a broad range of ultraviolet light on the surface of the object to be authenticated, thereby facilitating quick scanning of an anticounterfeit feature (b).

In the anticounterfeit feature authentication pen of the invention, the power switch 34 can be flexibly embedded in the tubular wall of the pen barrel rear portion at a suitable position to provide the same function.

In sum, the invention is practical to use. By using a lighting device employing a black cold cathode tube as light source and disposed in the pen barrel rear portion, the present invention is space-saving and portable compared with the conventional currency authentication pen described above. As compared with conventional LED type currency authentication pen, the present invention provides enhanced authentication effect for anticounterfeit features of different wavelengths.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An anticounterfeit feature authentication pen, comprising a pen barrel which includes detachably connected front and rear portions, said pen barrel front portion having a refill disposed therein for writing purposes, said pen barrel rear portion having a lighting device disposed therein for authenticating anticounterfeit features, wherein said pen barrel rear portion having a tubular wall formed with an elongate hole that is sealed by a light permeable plate, said lighting device including an activator circuit board disposed in said pen barrel rear portion, a light reflective hood disposed at an inner face end of said light permeable plate, a black cold cathode tube disposed between said light reflective hood and said light permeable plate, a button type battery seat insertable and removable via a connecting end of said pen barrel rear portion, and a power switch disposed at said pen barrel rear portion at a suitable position.

2. The anticounterfeit authentication authentication pen as claimed in claim 1, wherein said power switch can be embedded in said pen barrel rear portion at any suitable position.
